(19) United States
(12) Patent Application Publication
(10) Pub. No.: US 2007/0291474 A1
(43) Pub. Date: Dec. 20, 2007

(54) LED ILLUMINATION FOR HANDHELD TOOLS

(76) Inventor: Jason K. Hui, Fresno, CA (US)

Correspondence Address: CARSTENS & CAHOON, LLP, P O BOX 802334, DALLAS, TX, 75380, US

(21) Appl. No.: 11/763,318

(22) Filed: Jun. 14, 2007

Related U.S. Application Data
(60) Provisional application No. 60/804,683, filed on Jun. 14, 2006.

(51) Int. Cl. F21V 33/00

(52) U.S. Cl. 362/109

(57) ABSTRACT

An illumination source for illuminating the jaws of a handheld tool near the tool's working tip. At least one LED is mounted on a handheld tool such that when energized, the LED light encircles the tips of the tool's jaws and illuminates the working surface. The illumination source may be permanently integrated with the tool or may be retrofit. A power source and a switch are provided to energize the LEDs. The power source may or may not be serviceable. If the working environment is corrosive or otherwise hazardous, the entire illumination source may be sealed to prevent sparks or corrosion of the internal parts.

### CROSS-REFERENCE TO RELATED APPLICATIONS

This application claims the benefit of U.S. Provisional Application No. 60/804,683, filed Jun. 14, 2006.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to an apparatus that provides illumination directly to the working site of a handheld tool. More specifically, the invention relates to an LED illumination source that may be retrofit onto existing handheld tools or may be incorporated into a handheld tool design.

2. Description of Related Art Including Information Disclosed Under 37 CFR 1.97 and 1.98

Many handheld or manual tools such as pliers, mitten clamps, hemostats, and scissors are often used in low light or dark conditions. In such conditions, an external or additional light source is frequently employed to sufficiently illuminate the working surface or object at the end of such handheld tool. Providing such additional illumination is often difficult and inconvenient especially where the handheld tool and working material are being held in opposite hands wherein a single user has no easy means for holding and directing such additional source of illumination.

One particular circumstance where additional illumination is especially useful is when removing a hook or barb from a fish. When a fish swallows a hook or lure, the barb becomes embedded into its tissues inside its gullet. For a catch and release, it becomes necessary to adroitly choose an angle or removal and apply the right force to the hook in order to remove it without causing unnecessary tearing of the fish's tissue. Such task requires illumination, especially at night when there are few sufficiently strong illumination sources. Such illumination is often difficult to acquire when a fisherman is holding a handheld tool such as a pair of pliers in one hand, and the fish in the other.

There remains a need for an illumination source that provides continuous light to the working end of a handheld tool. A further need exists for a light source that does not cast shadows when the mouth or working end of the tool is open, closed, or somewhere in between. A further need exists for a light source that can be accessed or triggered with the hand that is also holding the tool. Such need exists for handheld tools used by plumbers, electricians, mechanics, doctors, dentists, and fishermen, among others. The present invention fills these and other needs as detailed more fully below.

### BRIEF SUMMARY OF THE INVENTION

An improved source of illumination is attached or embedded into a handheld tool. Two LED lights, each mounted on opposing sides of a handheld gripping or cutting tool such as a mitten clamp, hemostat, pliers, scissor, and the like provide illumination without shadow around the working end of the tool. The light source may be activated by the same hand gripping the handheld tool and provides 360 degree illumination of the working surface or object.

The apparatus may be retrofit onto an existing hand tool or integrated into a hand tool design. The LED illumination source is small enough such that it can be attached to the jaws or handle and provide illumination to the working end of the tool. The power source can be either a replaceable or permanent battery. A permanent battery could be used in situations where the tool life is not expected to exceed the battery life. Because the LED requires little power, the battery can be compact yet still allow sufficient life. A switch allows the LED illumination source to energize intermittently or to remain on constantly.

The invention accordingly comprises the features described more fully below, and the scope of the invention will be indicated in the claims. Further objects of the present invention will become apparent in the following detailed description.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, in which like reference numbers refer to like parts throughout the views, wherein:

FIG. 1 represents a perspective view of a mitten clamp and a hemostat each of which is retrofitted with an improved illumination source according to one embodiment of the present invention;

FIG. 2A represents a perspective view of a pair of pliers in the closed position with an improved LED light source integrated into the pliers' components according to one embodiment of the present invention; and,

FIG. 2B represents a perspective view of the pair of pliers shown in FIG. 2A in the open position according to one embodiment of the present invention;

Where used in the various figures of the drawing, the same reference numbers designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood 58,266.

### DETAILED DESCRIPTION OF THE INVENTION

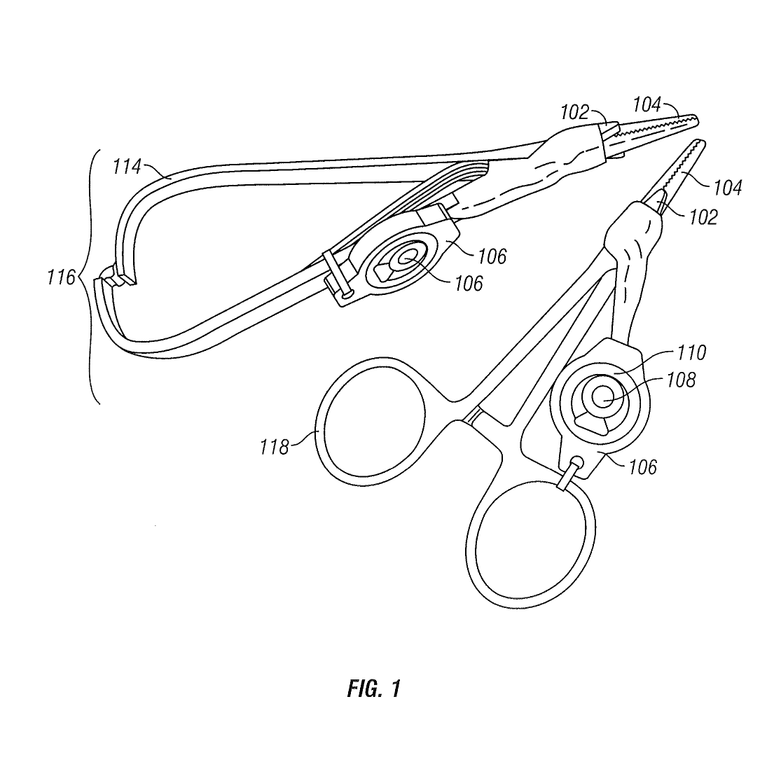

FIG. 1 shows a mitten clamp 116 and hemostat 118 wherein each are retrofitted with an LED light system according to one embodiment of the present invention. In this embodiment, two LED lights 102 are affixed near the jaws 104 of each of the respective instruments 116, 118. The LED lights 102 are kept in place by tightly wound tape or tightly fitting sleeve of synthetic or other type of material. Wires lead up to a battery or other electric source 108 (hereinafter referred to simply as “battery”), a switch 110, and a switch housing 106.

The battery 108, switch 110, and switch housing 106 are mounted near the gripping portion of each instrument, opposite from the working end (i.e., jaws) 104 of the instrument so as to avoid any mechanical interference with the jaws of the instrument and to prevent unnecessary exposure of the electrical connections to liquids or damaging contact. The LED lights 102 are located near the jaws 104 of the instrument or handheld tool. The switch housing 106 is located so as to be within reach of the hand, thumb or fingers of the hand, gripping either the mitten clamp 116 or hemostat 118 along the instrument's handle 114. When desired, the operator activates the switch 110 which subsequently powers the LED lights 102.

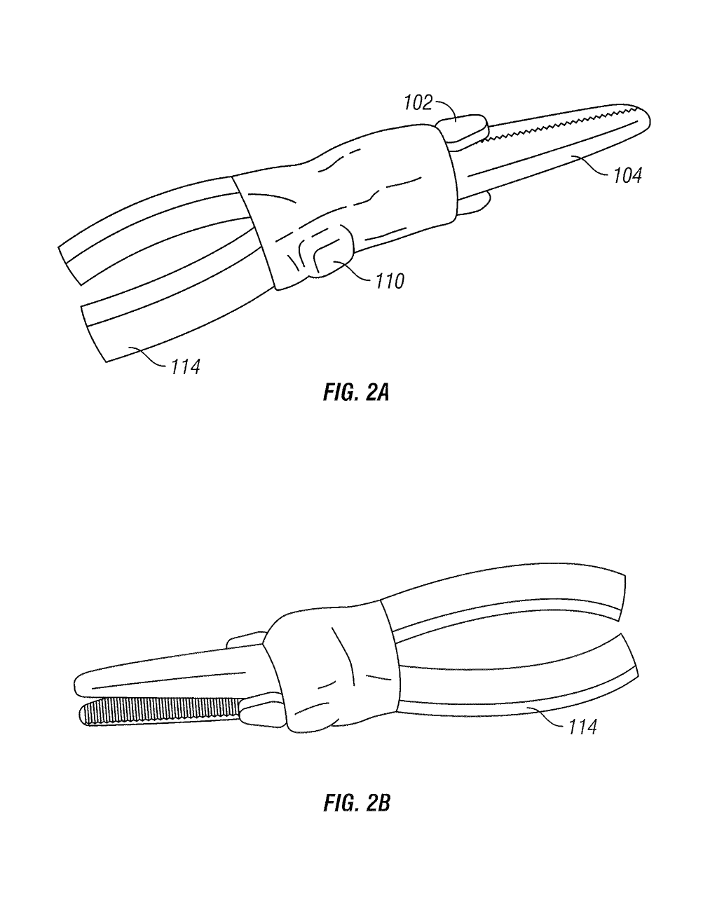

FIG. 2A shows an improved pair of pliers according to a preferred embodiment of the present invention. In this embodiment, at least one LED light 102 is integrally housed along each side of its jaws 104. A switch 110, electrical wires (not visible) and battery (not visible) are also integrally housed in or near the handle 114. As with the mitten clamp 116 and hemostat 118 shown in FIG. 1, the pliers of FIG. 2 utilize a similar battery housing with a battery and switch 110 to power the LED 102.

The embodiment of FIG. 2 conceals the housing beneath the attachment means. In this embodiment, the attachment means can be either tightly wound tape or a tightly fitting sleeve of synthetic or other type material. With respect to FIG. 1, another means of attaching the battery housing 106 to the handle 114 is with nylon cable ties in conjunction with common heat shrinkable tubing. Other means for attachment include hook and loop fastener sold under the trademark VELCRO®, double-sided tape, epoxy, or the like.

The means chosen for attachment can be readily adapted for the desired usage of the tool. For instance, with respect to both FIGS. 1 and 2, tools utilized in certain chemical environments may require an attachment means made of a synthetic material that resists the chemicals to which it is exposed while providing a tight seal around the handle of the tool and effectively isolating the battery housing 106 from potential chemical exposure. In less hazardous or demanding environments it may be suitable to utilize tightly wound tape to attach the battery housing 106 to the handle 114 and LEDs 102 near the jaws 104.

Still, other embodiments may utilize a battery housing that is built entirely inside the handle at the time that the tool is either cast or machined such that the handle and battery housing are inseparable integral components. In this embodiment, the wiring and LED lights are also built into the handle and jaws of the tool such that there are no externally visible components, except for the openings at the ends of the jaws for the LED light to shine upon the work surface or object being manipulated.

With respect to FIGS. 1 and 2, The LED 102 provides light without casting shadows at and near the working surface or object. The battery and wires are protected from harm by the housing. FIG. 1 shows a battery housing 106 that is accessible for easy replacement of the battery. However, it is entirely possible that some tools may require permanently sealed battery housings for safety reasons. For instance, certain explosive environments require tools made of brass or other soft metals that will not spark when used. In this situation a permanently sealed battery housing and battery switch that is rated “explosion resistant” would be required. However, since LED lights use so little electrical power a lithium type battery installed in the permanently sealed battery housing would still likely provide years of service before the tool requires replacement. Thus, the housing may or may not be provided with a re-closable feature for accessing and replacing the batteries. This allows the housing to be sealed against fluids so as to remain water resistant, spark resistant, and/or corrosion resistant.

FIG. 2B shows the improved pair of pliers shown in FIG. 2A with its jaws open 104. With reference to FIG. 2B, the illumination from the LED lights 102 cast light 360 degrees around the pliers as well as within the jaws 104 of the pliers. In this way, sufficient illumination is maintained on the working surface or object as the user manipulates the pliers' jaws 104. Such easily obtained light can be used in a variety of tasks such as plumbing, automotive, construction, electrical work, military operations, and recreational tasks such as fishing, hiking, or the like. Such illumination may also be useful in medical applications in which a small, tight or darkened space necessitates additional light.

In another embodiment, the integrated LED lights 102 can be used in conjunction with a tool with replaceable tips so that one illumination source can be used with a variety of tool types. Also, when space is very tight and when precise illumination is required it is possible to channel the LED light along fiber optic cables. The use of fiber optic cables would allow the relatively larger LED lights to be positioned much higher on the tool's handle away from the working end. Thus, the working end of the tool can be made much more compact.

While the invention has been particularly shown and described with reference to a preferred embodiment, it will be understood by those skilled in the art that various changes in form and detail may be made therein without departing from the spirit and scope of the

I claim:

1. An illumination apparatus for retrofitting a handheld tool such as a hemostat, mitten clamp, pliers, scissors, or other gripping, fastening, or cutting tool, the illumination apparatus comprising:
at least one LED, wherein the at least one LED is positioned to provide illumination to the working end of the tool which is opposite the handle end of the tool;
an electric current source, the source sufficient to power the at least one LED; and
a switching means, the switching means for completing the electrical circuit between the source and the at least one LED.

2. The illumination apparatus of claim 1, the illumination apparatus further comprising:
an attachment means, the attachment means for attaching the at least one LED, the source, and the switching means to the tool.

3. The illumination apparatus of claim 1 wherein the electric current source comprises at least one replaceable battery.

4. The illumination apparatus of claim 1 wherein the electric current source is permanently sealed.

5. The illumination apparatus of claim 1 wherein the illumination apparatus is water resistant.

6. The illumination apparatus of claim 1 wherein the illumination apparatus is corrosion resistant.

7. The illumination apparatus of claim 1 wherein the illumination apparatus is explosion resistant.

8. The illumination apparatus of claim 1 wherein the at least one LED utilizes fiber optic cable to transmit light to the working end of the tool.

9. An improvement to a handheld tool such as a hemostat, mitten clamp, pliers, scissors, or other gripping, fastening, or cutting tool, the improvement comprising:
at least one LED, wherein the LED is positioned to provide illumination to the working end of the tool which is opposite the handle of the tool;
an electric current source, the source sufficient to power the at least one LED; and
a switching means, the switching means for completing the electrical circuit between the electric current source and the at least one light emitting diode.

10. The improvement of claim 9, the improvement further comprising:
an attachment means, the attachment means for attaching the at least one LED, the source, and the switching means to the tool.

11. The improvement of claim 9 wherein the electric current source comprises at least one replaceable battery.

12. The improvement of claim 9 wherein the electric current source comprises at least one replaceable battery.

13. The improvement of claim 9 wherein the electric current source is permanently sealed.

14. The improvement of claim 9 wherein the improvement is water resistant.

15. The improvement of claim 9 wherein the improvement is corrosion resistant.

16. The improvement of claim 9 wherein the improvement is explosion resistant.

17. The improvement of claim 9 wherein the at least one LED utilizes fiber optic cable to transmit light to the working end of the tool.

18. The improvement of claim 9 wherein the at least one LED, the electric current source, and the switching means are removeably attached to the tool.

19. The improvement of claim 9 wherein the at least one LED, the electric current source, and the switching means are integrated within the body of the tool.
